(19) United States
(12) Patent Application Publication
(10) Pub. No.: US 2005/0248426 A1
(43) Pub. Date: Nov. 10, 2005

(54) Core for a coil winding

(75) Inventor: Huo-Li Lin, Taipei City (TW)

Correspondence Address: DENNISON, SCHULTZ, DOUGHERTY & MACDONALD, 1727 KING STREET, SUITE 105, ALEXANDRIA, VA, 22314, US

(73) Assignee: TRIO TECHNOLOGY CO., LTD.

(21) Appl. No.: 10/841,452

(22) Filed: May 10, 2004

(51) Int. Cl. H01F 27/02

(52) U.S. Cl. 336/83

(57) ABSTRACT

A core for a coil winding includes a T-shaped main body having a vertical plate and a horizontal column laterally projected from a central area of a right side of the vertical plate for a coil to wind therearound, and a cover portion assembled to a right side of the main body. The cover portion defines an inner space and includes at least communicable open left and upper sides. The horizontal column and the coil are located in the inner space of the cover portion, so that the core is a rectangular parallelepiped enabling effective space utilization. An inductance or impedance of the coil winding can be adjusted through changing a clearance between the main body and the cover portion. The coil may be separately mass-produced in advance and then assembled to the horizontal column of the main body to increase the productivity of the coil winding.

### FIELD OF THE INVENTION

The present invention relates to a core for a coil winding, and more particularly to a core that allows convenient assembling of a coil thereto, adjustment of an inductance or impedance of the coil winding, and effective space utilization.

### BACKGROUND OF THE INVENTION

An induction coil is one type of current-carrying conductor. When an amount of current is supplied to the current-carrying conductor, a magnetic field is produced. Therefore, the current-carrying conductor may be used to manufacture different electronic components, such as coils, inductances, or transformers.

The above-mentioned different electronic components of coils, inductances, and transformers typically include a core and a coil wound around the core. The coil is usually made of a metal wire or strip.

FIG. 1 shows a conventional annular core 11 and a coil 12 wound around the core 11 to form a coil winding. In a space having fixed length, width, and height, the annular core 11 has a relatively low rate of space utilization and provides small energy storage effect. Moreover, the annular core 11 does not allow adjustment of an inductance or impedance thereof.

FIGS. 2 and 3 are exploded and assembled perspective views, respectively, of another conventional core and coil for a coil winding, in which the core 21 is a horizontal I-shaped member with the coil 22 being wound therearound. A cover plate 23 is then closed to an open top of the horizontal I-shaped core 21. Pads 24 are provided between four upper corners of the horizontal I-shaped core 21 and the cover plate 23 for the purpose of adjusting a clearance between the cover plate 23 and the assembled core and coil 21, 22 and accordingly the inductance or impedance of the coil. To obtain different clearances between the cover plate 23 and the core 21, different number of pads 24 with similar or different thickness may be used.

With the core and coil structure shown in FIGS. 2 and 3, a rectangular parallelepiped coil winding may be obtained to achieve a high rate of space utilization, and the clearance between the cover plate 23 and the core 21 may be adjusted with the pads 24 to thereby adjust the inductance or the impedance of the coil winding. However, following disadvantage is found in the production and the use of the conventional core 21: since the horizontal I-shaped core 21 has two closed lateral ends, the coil 22 could not be separately formed in advance and then put around the core 21 from either end thereof. Instead, the coil 22 must be formed on the core 21 by directly winding a metal wire or strip around the core 21, resulting in lowered productivity of the coil winding.

It is therefore tried by the inventor to develop an improved core for a coil winding to eliminate the drawback existed in the conventional cores.

### SUMMARY OF THE INVENTION

A core for a coil winding according to the present invention includes a substantially T-shaped main body having a vertical plate and a horizontal column laterally projected from a central area of a right side of the vertical plate for a coil to wind therearound, and a cover portion mounted to a right side of the main body. The cover portion includes at least an open left side and an open top that are communicable with each other to expose an inner space of the cover portion to external environment. The horizontal column with the coil mounting therearound is located in the inner space of the cover portion. An assembly of the main body and the cover portion is a substantially rectangular parallelepiped enabling effective space utilization. An inductance or impedance of the coil winding may be adjusted through moving the main body and the cover portion toward or away from each other to change a clearance between them. The coil may be separately mass-produced in advance and then assembled to the horizontal column of the main body to increase the productivity of the coil winding.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a first type of conventional core and coil for forming a coil winding;

FIG. 2 is an exploded perspective view of another type of conventional core and coil for forming a coil winding;

FIG. 3 is an assembled view of FIG. 2;

FIG. 4 is an exploded perspective view of a core for a coil winding according to a first embodiment of the present invention;

FIG. 5 is an assembled view of FIG. 4;

FIG. 6 is a top plan view of FIG. 5;

FIG. 7 is a sectioned side view of FIG. 6;

FIG. 8 is a top plan view showing the manner of adjusting a clearance on the core of the present invention shown in FIG. 5;

FIG. 9 is a sectioned side view of FIG. 8;

FIG. 10 is a top plan view of a core for a coil winding according to a second embodiment of the present invention;

FIG. 11 is a sectioned side view of FIG. 10;

FIG. 12 is a top plan view of a core for a coil winding according to a third embodiment of the present invention;

FIG. 13 is a sectioned side view of FIG. 12;

FIG. 14 is a perspective view of a first variant of a cover portion for the core of the present invention;

FIG. 15 is a perspective view of a second variant of the cover portion for the core of the present invention; and

FIG. 16 is a perspective view of a third variant of the cover portion for the core of the present invention.

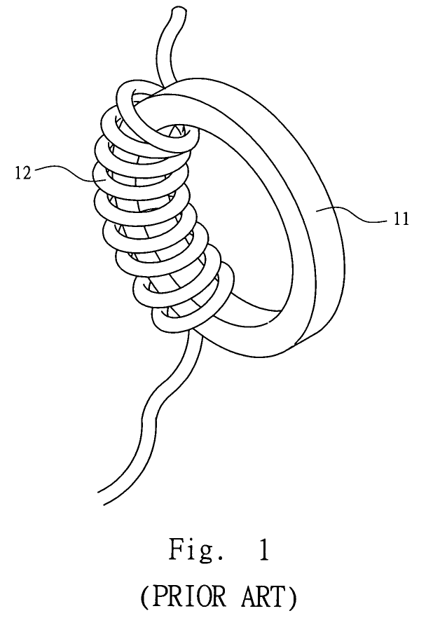

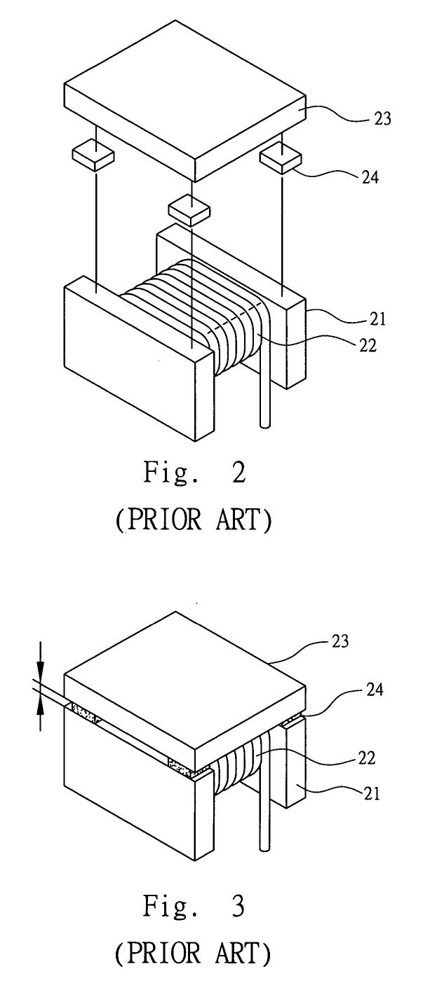

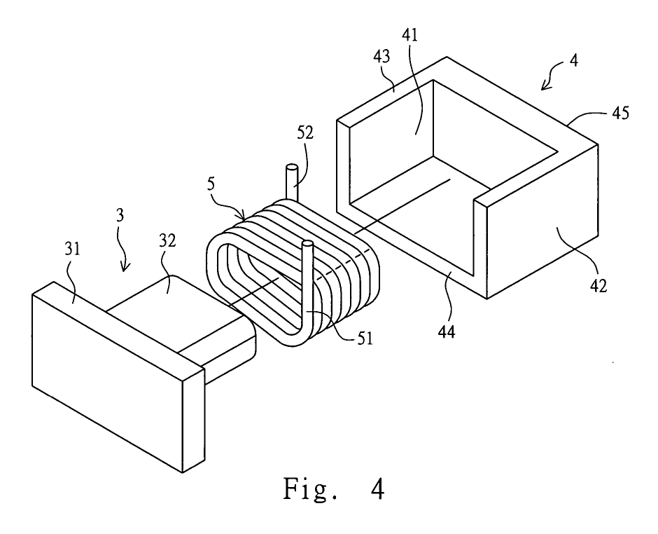

### DETAILED DESCRIPTION OF THE PREFERRED EMBODIMENTS

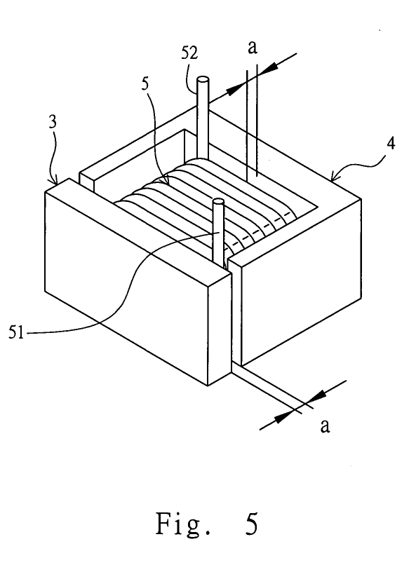

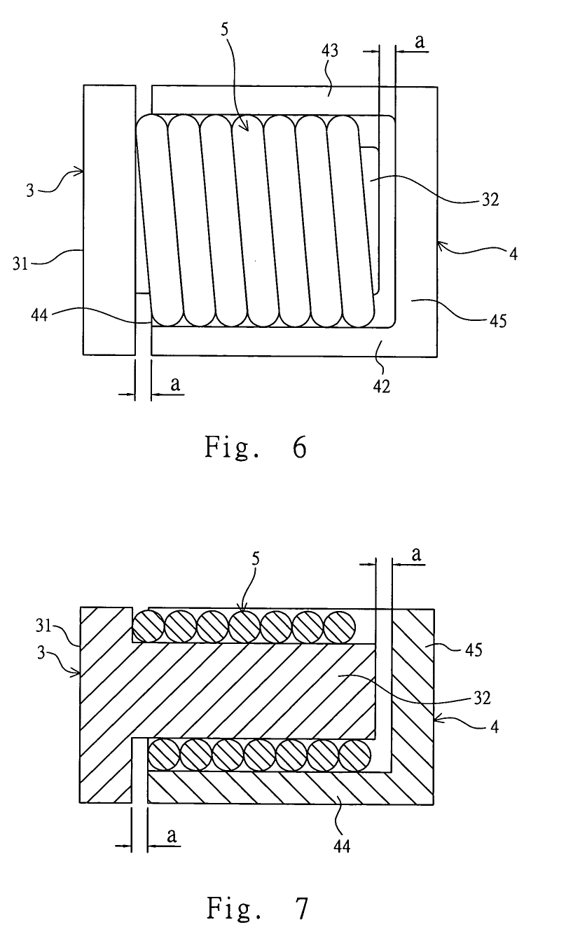

Please refer to FIGS. 4 to 7, in which a core for a coil winding according to a first embodiment of the present invention is shown. As shown, the core of the present invention includes a main body 3 and a cover portion 4.

The main body 3 is a substantially T-shaped member having a vertical plate 31 and a horizontal column 32 laterally projected from a central area of one side of the vertical plate 31. In the illustrated embodiment, the horizontal column 32 is laterally projected from the central area of a right side of the vertical plate 31.

A coil 5 formed by winding a metal wire or a metal strip is fitted around the horizontal column 32 of the main body 3 of the core. To facilitate easy fitting of the coil 5 around the horizontal column 32, corners of the horizontal column 32 are chamfered. The coil 5 is provided at front and rear ends with outward projected beginning section 51 and ending section 52, respectively. The beginning and the ending section 51, 52 are formed into a configuration, such as a cylindrical or a flat configuration, that is suitable for electrical connection with other wiring elements. The coil 5 may be made of metal wires of different cross sections, such as round as shown in the illustrated embodiment, flat, or any other suitable shapes. Moreover, the coil 5 may be formed through winding of one single wire, or multiple parallel wires or strips.

The cover portion 4 of the core is designed for mounting to one side of the main body 3 having the horizontal column 32. That is, for the embodiment shown in FIGS. 4 to 7, the cover portion 4 is mounted to a right side of the main body 3. In a feasible embodiment of the cover portion 4, at least a left side and a top thereof are open and communicable with each other to expose an inner space 41 of the cover portion 4 to external environment. More specifically, the cover portion 4 includes a front wall 42, a rear wall 43, a bottom wall 44, and a right wall 45. The right wall 45 is located at a right end of the bottom wall 44 to upward extend therefrom, the front wall 42 is located at front ends of the bottom wall 44 and the right wall 45 to upward extend therefrom, and the rear wall 43 is located at rear ends of the bottom wall 44 and the right wall 45 to upward extend therefrom. The walls 42, 43, 44, and 45 are located at outer sides of the inner space 41 to partially enclose the same. The horizontal column 32 and the coil 5 wound therearound are located in the inner space 41 with the beginning and the ending section 51, 52 of the coil 5 extended in, for example, an upward direction to project from the inner space 41.

After the cover portion 4 is assembled to the main body 3, the vertical plate 31 of the main body 3 naturally closes the open left side of the cover portion 4. Thus, an assembly of the main body 3 and the cover portion 4 is substantially an open-topped rectangular parallelepiped. A rectangular parallelepiped core is particularly suitable for use in a space having fixed length, width, and height to enable fully effective space utilization and enhanced energy storage effect.

As having been mentioned above, the main body 3 of the core is a substantially T-shaped member having one open end, allowing the coil 5 to be separately mass-produced in advance and then put around the horizontal column 32 from a free end thereof. In this manner, a coil winding formed from the core of the present invention and the coil 5 may be mass-produced at increased speed and upgraded productivity.

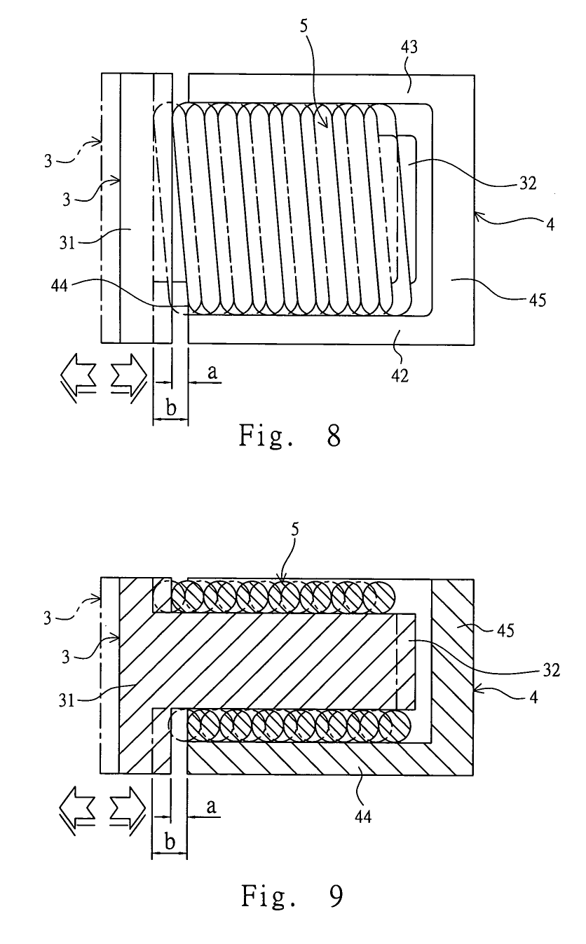

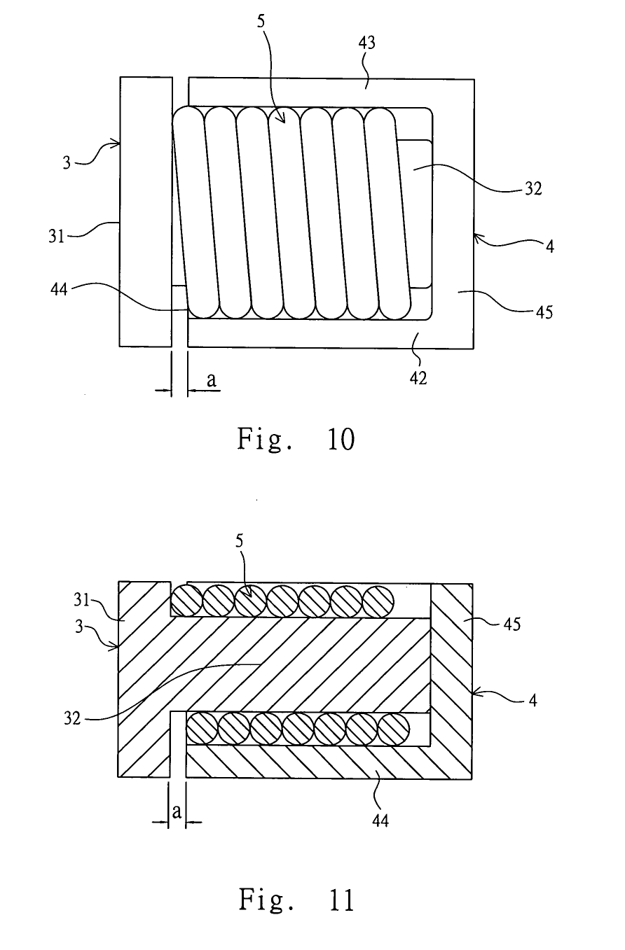

An inductance of the coil 5 may be adjusted through adjustment of clearances between the main body 3 and the cover portion 4 of the core, so as to achieve the effects of low power consumption and high energy storage Please refer to FIGS. 8 and 9 that describes the manner of adjusting the clearances between the main body 3 and the cover portion 4 of the core of the present invention. As shown, the main body 3 and the cover portion 4 may be shifted toward or away from each other to change the clearances between them. For example, it is possible for a left side of the right wall 45 of the cover portion 4 to closely contact with a right end of the horizontal column 32 of the main body 3, while a left end of the bottom wall 44 of the cover portion 4 closely contacts with a right side of the vertical plate 31 of the main body 3. Or alternatively, it is possible for a clearance “a” or “b” to exist between the left side of the right wall 45 of the cover portion 4 and the right end of the horizontal column 32 of the main body 3, while the same clearance “a” or “b” exists between the left end of the bottom wall 44 of the cover portion 4 and the right side of the vertical plate 31 of the main body 3. After adjustment of the clearances between the main body 3 and the cover portion 4 of the core, pads may be mounted at necessary positions between the cover portion 4 and the main body 3 having the coil 5 wound therearound, and bonding material is applied or adhesive tape is used to firmly connect the main body 3 to the cover portion 4.

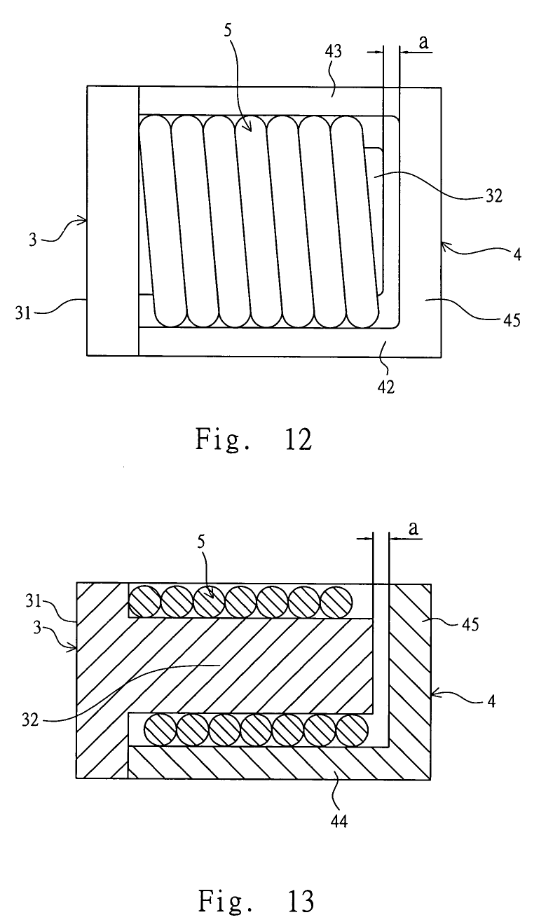

FIGS. 10 and 11 are top plan and sectioned side views, respectively, of a core for a coil winding according to a second embodiment of the present invention. In the second embodiment, the left side of the right wall 45 of the cover portion 4 closely contacts with the right end of the horizontal column 32, while a clearance “a” exists between the left end of the bottom wall 44 of the cover portion 4 and the right side of the vertical plate 31.

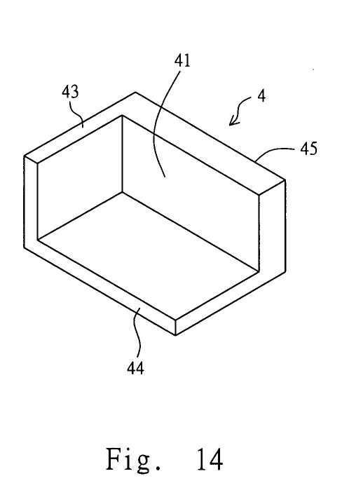

FIGS. 12 and 13 are top plan and sectioned side views, respectively, of a core for a coil winding according to a third embodiment of the present invention. In the third embodiment, a clearance “a” exists between the left side of the right wall 45 of the cover portion 4 and the right end of the horizontal column 32, while the left end of the bottom wall 44 of the cover portion 4 closely contacts with the right side of the vertical plate 31.

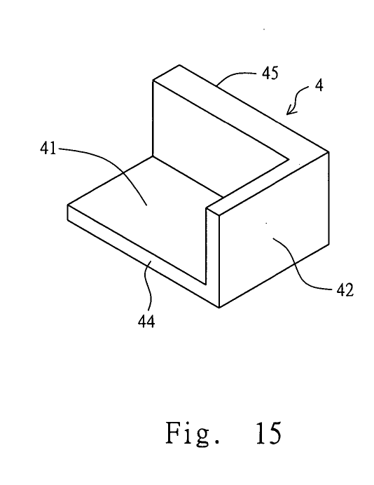

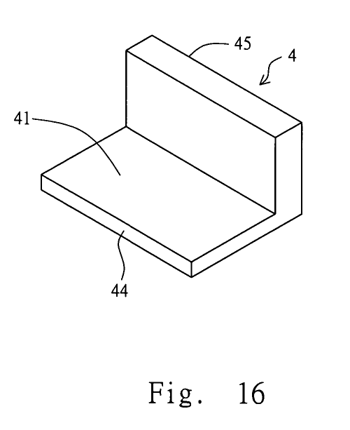

FIG. 14 is a perspective view of a first variant of the cover portion 4 of the core of the present invention. In the first variant, the cover portion 4 includes only a bottom wall 44, a right wall 45, and a rear wall 43 to partially enclose the inner space 41. FIG. 15 is a perspective view of a second variant of the cover portion 4 of the core of the present invention. In the second variant, the cover portion 4 includes only a bottom wall 44, a right wall 45, and a front wall 42 to partially enclose the inner space 41. FIG. 16 is a perspective view of a third variant of the cover portion 4 of the core of the present invention. In the third variant, the cover portion 4 includes only a bottom wall 44 and a right wall 45, and all other sides are open and communicable with one another to expose the inner space 41. All the above-described cover portions 4 are functionally equivalent in the core of the present invention.

1. A core for a coil winding, comprising:
a main body which is a substantially T-shaped member having a vertical plate and a horizontal column laterally projected from a central area of a right side of said vertical plate for a coil to wind therearound; and
a cover portion which is located at a right side of said main body, and includes at least a bottom wall and a right wall vertically upward extended from a right end of said bottom wall; and said cover portion having at least an open left side and an open top that are communicable with each other to expose an inner space of said cover portion to external environment; said bottom wall and said right wall being located at an outer side of said inner space, and said horizontal column of said main body and said coil mounted around said horizontal column being located in said inner space of said cover portion.

2. The core for a coil winding as claimed in claim 1, wherein said cover portion further includes a front wall vertically upward extended from front ends of said bottom wall and said right wall.

3. The core for a coil winding as claimed in claim 1, wherein said cover portion further includes a rear wall vertically upward extended from rear ends of said bottom wall and said right wall.

4. The core for a coil winding as claimed in claim 1, wherein said cover portion further includes a front wall vertically upward extended from front ends of said bottom wall and said right wall, and a rear wall vertically upward extended from rear ends of said bottom wall and said right wall.

5. The core for a coil winding as claimed in claim 1, wherein a left side of said right wall of said cover portion closely contacts with a right end of said horizontal column of said main body, and a left end of said bottom wall of said cover portion also closely contacts with a right side of said vertical plate of said main body.

6. The core for a coil winding as claimed in claim 1, wherein a first clearance exists between a left side of said right wall of said cover portion and a right end of said horizontal column of said main body, and a second clearance exists between a left end of said bottom wall of said cover portion and a right side of said vertical plate of said main body.

7. The core for a coil winding as claimed in claim 1, wherein a left side of said right wall of said cover portion closely contacts with a right end of said horizontal column of said main body, while a clearance exists between a left end of said bottom wall of said cover portion and a right side of said vertical plate of said main body.

8. The core for a coil winding as claimed in claim 1, wherein a clearance exists between a left side of said right wall of said cover portion and a right end of said horizontal column of said main body, while a left end of said bottom wall of said cover portion closely contacts with a right side of said vertical plate of said main body.

9. The core for a coil winding as claimed in claim 1, wherein said horizontal column has chamfered corners.

10. The core for a coil winding as claimed in claim 1, wherein an assembly of said main body and said cover portion is substantially a rectangular parallelepiped.

11. The core for a coil winding as claimed in claim 1, wherein said coil includes a beginning section and an ending section outward projected from said inner space of said cover portion.

12. The core for a coil winding as claimed in claim 11, wherein said beginning and said ending section of said coil have a configuration suitable for electrically connecting to other wiring elements.
